(19) United States
(12) Patent Application Publication
(10) Pub. No.: US 2026/0326809 A1
(43) Pub. Date: Oct. 22, 2026

(54) Modular Hanging Infant Support System for Stroller Integration

(71) Applicants: Daniel Zambrana Herrero, Alcobendas (ES); Marta Paz Yusty Tenorio, Alcobendas (ES)

(72) Inventors: Marta Paz Yusty Tenorio, Alcobendas (ES); Daniel Zambrana Herrero, Alcobendas (ES)

(21) Appl. No.: 19/211,228

(22) Filed: May 18, 2025

Related U.S. Application Data
(60) Provisional application No. 63/791,447, filed on Apr. 19, 2025.

(51) Int. Cl. B62B 9/28; B62B 9/24

(52) U.S. Cl. CPC B62B 9/28; B62B 9/24

(57) ABSTRACT

A modular hanging support system for transporting an additional child, suspended from the chassis of a baby stroller, without replacing or interfering with the stroller's built-in seat. The system includes a support surface made of flexible, semi-rigid, or rigid material, along with multiple suspension elements configured to attach the support surface to the stroller chassis. Optional features include a child restraint system, an adjustable headrest, breathable textile zones, integrated storage pockets, a deployable canopy, and a folding mechanism that allows the system to be rolled into an integrated textile bag. The invention provides a hygienic, ergonomic, compact, and easily adaptable auxiliary seating solution that requires no structural modification to the stroller on which it is mounted.

### 2. BACKGROUND OF THE INVENTION

Various auxiliary seating systems have been proposed over time for transporting a second child in a stroller. However, many existing solutions fail to address key requirements related to adaptability, safety, hygiene, ergonomics, breathability, and compact storage capability.

For example, some systems adopt a sidecar configuration, with a narrower secondary seat attached laterally to the stroller. These increase the total width of the stroller, making it impractical to pass through doors or narrow sidewalks. Other products use ride-on boards mounted to the rear axle, which obstruct the caregiver's stride and force awkward body posture, especially on inclines. A further approach involves hanging seats suspended from the stroller handlebar, which place the entire weight of the second child on the handle and may cause instability or unsafe sway during movement.

Earlier U.S. patents such as U.S. Pat. Nos. 2,641,57A, 1,302,444A, 1,372,538A, 2,517,785A, and 2,751,232A disclose rudimentary child support systems, often rigid or suspended, but based on outdated materials and lacking integrated textile functionality or ergonomic modularity. More recent patents such as U.S. Pat. Nos. 3,998,490A, 6,099,022A, 6,644,739B2, EP0677262A1, EP3363711A1, and FR3062838A1 introduce detachable or auxiliary seat modules, mostly rigid, with limited adaptation to textile integration, hygienic ventilation, or autonomous structural design.

Existing auxiliary seats, such as the rigid bench-type designs described in patents like EP1325855A1, rely on mechanical brackets and structural extensions to mount onto stroller frames. While such systems offer structural support, they lack integration of breathable textile elements, modular comfort features, folding functionality, and compatibility with diverse stroller designs.

Accordingly, there remains a need for a suspended auxiliary seating solution that is fully textile-based, structurally independent, foldable, ergonomically adaptable, and seamlessly integrable with existing stroller frames—without requiring rigid hardware, permanent attachment, or structural modification.

### 3. SUMMARY OF THE INVENTION

The present invention provides a modular, suspended infant support system designed for seamless integration with baby stroller frames. Unlike traditional seats or rigid modules, the system is based on a breathable, hygienic textile structure that is suspended from the stroller chassis via adjustable anchoring points. It operates independently of the stroller's original seating and incorporates ergonomic adaptability, a compact folding mechanism, and optional modular components such as an integrated canopy, storage pockets, or a headrest.

None of the prior art systems suggest or combine these functional aspects within a single structure. Prior solutions rely on rigid frames or limited modularity, whereas the present invention introduces a fully textile-based, suspended support that folds into a self-contained pouch, adjusts to different child sizes, and integrates breathable zones and hygienic materials. This results in a structurally autonomous and ergonomic solution that overcomes the limitations of traditional auxiliary seats.

### 4. BRIEF DESCRIPTION OF THE DRAWINGS

FIG. 1 is a perspective view of the auxiliary textile hammock suspended from the chassis of a baby stroller.

FIG. 2 shows a rear view of the hammock, with the flexible canopy partially emerging from the backrest opening.

FIG. 3 shows a side view of the hammock, in which the child restraint system, the extendable seatrest, the rear pocket, the breathable zones, and both upper and lower suspension attachments are visible.

FIG. 4 shows a perspective view of the hammock, taken from the front side at an angle, emphasizing the child restraint system including adjustable straps, locking elements, and a central release button.

FIG. 5 shows a rear-side perspective view of the hammock, angled to highlight the folding system and the integrated rear pocket, with visible connection to the upper suspension straps.

FIG. 6 shows a perspective view of the folding system in an open configuration, prepared to receive the rolled hammock. The hammock is shown in the process of being rolled, without the folding being fully completed.

FIG. 7 shows a perspective view of the hammock in its fully folded configuration, stored inside the integrated folding bag. The folding closure system is shown secured, with the suspensión attachments remaining connected to the upper anchoring points on the stroller chassis.

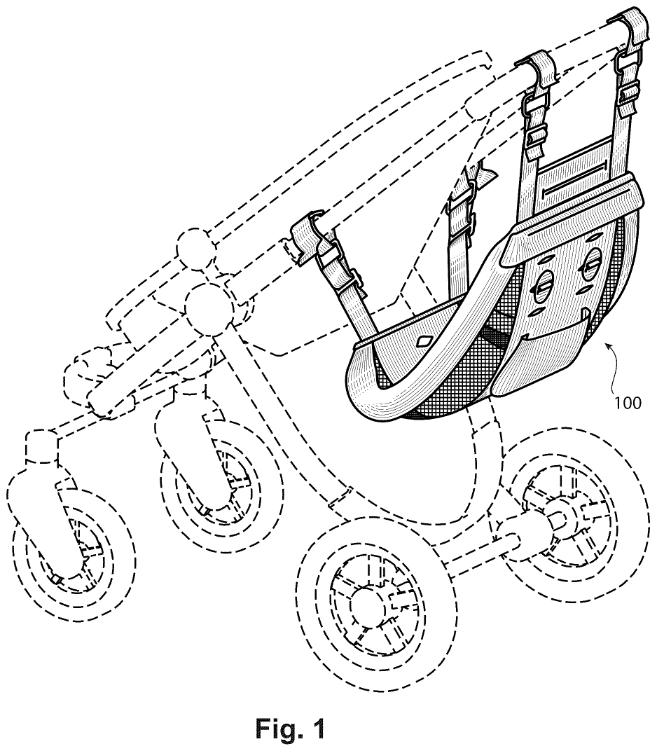

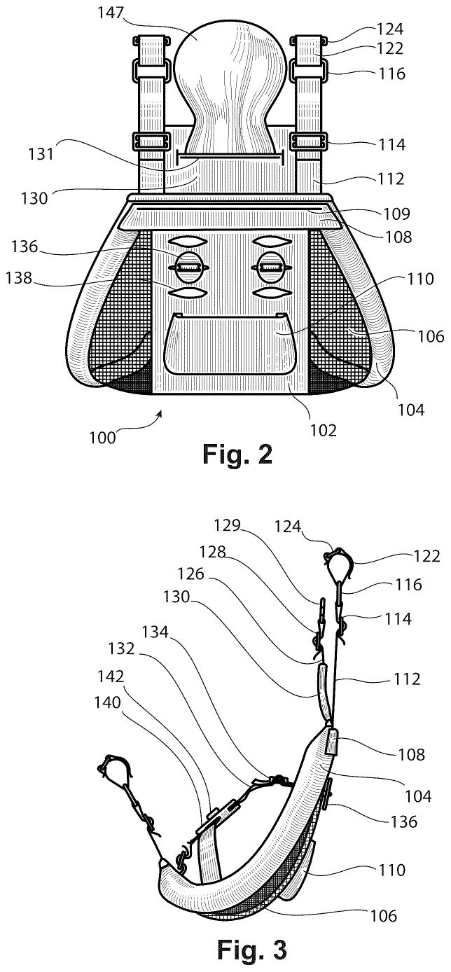

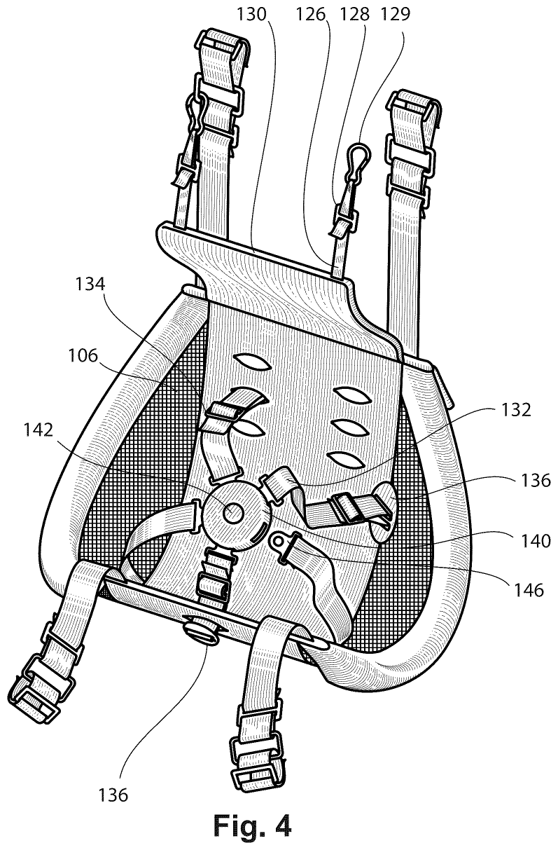

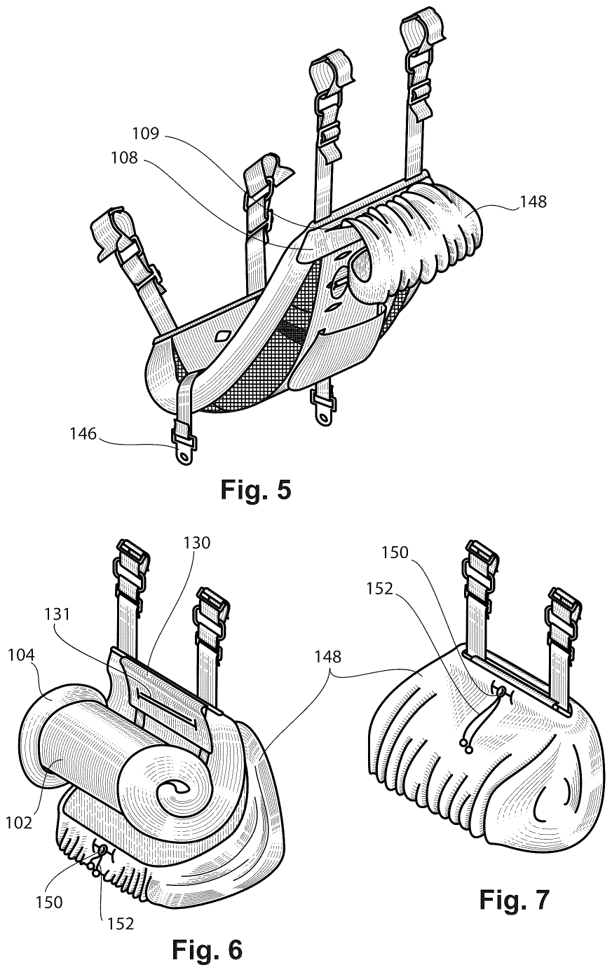

### 5. DETAILED DESCRIPTION OF THE INVENTION

The present invention relates, in its essential form, to an auxiliary textile hammock (100) designed for installation on baby strollers, providing a complete functional solution without the need for additional accessories. The main structure consists of a textile body (102) that serves as a support surface for the child, which may be padded or unpadded.

Lateral elements (104) may be arranged on both sides of the textile body to provide lateral stability to the assembly. These may also be padded or not, depending on the desired comfort level, without limiting the structural functionality of the hammock.

The hammock is attached to the stroller chassis via a four-point suspension system comprising adjustable attachment elements (122), which may include length adjustment means such as buckles (124) or other equivalent technical mechanisms, allowing adaptation to different stroller models.

The suspension straps (122) are not directly integrated into the main body but are connected via intermediate securing straps (112) through a functional connection element (116). This connection element (116) may take various technical configurations, such as fixed or removable joints, and is designed to ensure a secure link between the straps (122) and the intermediate straps (112). The illustrated embodiment represents only one possible implementation, without limiting the scope of the invention, which covers any technical means suitable for attaching the hammock to the stroller chassis.

The intermediate securing straps (112) are attached to the textile body (102) and include a height adjustment buckle (114) allowing the relative position of the hammock body with respect to the stroller chassis to be modified, facilitating adaptation to different stroller models and child sizes.

This functional separation between the height adjustment means (112, 114) and the anchoring means (122, 124) optimizes the system's stability, compatibility, and adaptability with various stroller designs. Unlike previous inventions, which do not clearly describe how the suspension and fixation elements interact, the present invention provides a segmented architecture that improves performance and versatility.

The proposed technical solution offers a structurally stable, secure, and adaptable autonomous textile hammock that integrates easily into commercial products without requiring additional components, enabling direct implementation. It should be understood that within the technical scope of the invention, constructional variations, material substitutions, or equivalent mechanisms may be incorporated, provided they fulfill the same technical function, without departing from the claimed scope.

The drawings are illustrative and non-limiting and may be replaced with functionally or constructively equivalent elements serving the same technical purpose, without altering the scope of the present invention.

The described invention may be mass-produced using conventional industrial techniques in the technical textile or baby product sectors and can be integrated into existing stroller systems without additional structural modification.

### Child Restraint System

The hammock may incorporate an integrated child restraint system designed to securely and ergonomically retain the child during use. This system includes straps (132) with adjustable length via regulation buckles (134) or equivalent technical mechanisms, allowing adaptation to different ages, body sizes, or required restraint levels. Each strap (132) connects to the textile body (102) via a fixation system that includes an insertable locking element (136) at its end. This element passes through reinforced holes (138) in the hammock body and is retained by its geometry and the load generated by the child's weight, preventing accidental release during normal use.

These straps (132) may be integrated with a quick-release coupling system (146), coordinated with a central union piece (140) and a release button (142). This button (142) allows simultaneous unlocking of all closures (146) connected to the textile body, enabling quick and safe disengagement of the child restraint system. Alternatively, the restraint system may include any other functional arrangement of straps, buckles, textile fasteners, or mechanical means fulfilling the safe retention function without being limited to the described configuration.

### Extendable Headrest

The structure may include an extendable headrest (130), projecting from the upper part of the backrest and connected by a strap (126), a length and tension adjustment buckle (128), and a carabiner (129) that also attaches to the connection buckle (116), allowing the headrest's position to be modulated according to the child's size or height, thus providing adequate and adaptable support for the head and upper body.

### Breathable Zones

To improve ventilation and thermal comfort, the seat may include breathable zones (106), preferably made of mesh or microperforated fabric, strategically placed to promote perspiration and airflow.

### Pockets

The system may integrate one or more pockets (110), attached to the hammock body by stitching, zippers, Velcro, or other equivalent technical means. These may be located on the rear or other accessible areas and serve to store personal items or accessories.

### Flexible Canopy

The hammock may incorporate a flexible canopy (147) that provides solar or climatic protection for the child. This canopy deploys from an opening (131), which may consist of a zipper, button, flap, or any other equivalent closure mechanism located at the top of the backrest.

### Folding System

The hammock may include a folding system to facilitate transport or compact storage. This system includes an opening (109) located inside an auxiliary pocket (108), from which a textile bag (148) can be extracted. The entire hammock may be rolled into this bag. Once folded, the hammock remains suspended from the stroller chassis via its upper anchoring points (122), remaining secured in a compact, stored configuration. The bag (148) is closed using an adjustment system (150), which may include a sliding closure or other mechanism acting on cords or tightening elements (152), allowing the set to remain secure during transport or storage.

### Materials

The flexible structural elements of the hammock are made from lightweight and adaptable materials, such as technical textiles, flexible plastics, or equivalent composites, provided they maintain the desired flexibility. Additionally, the system may incorporate hygienic or technical materials such as antibacterial, antimicrobial, or water-repellent fabrics, or certified materials (e.g., OEKO-TEX®), or other functionally equivalent materials offering safety, hygiene, and comfort for infant use.

Numbered elements forming part of the present invention include, specifically: the auxiliary textile hammock (100), the central portion of the hammock (102), the lateral padded elements (104), the breathable zones (106), the auxiliary folding pocket (108), the opening for extracting the storage bag (109), the rear pocket or other storage pockets (110), the height-adjustment straps (112), the length and position adjustment buckles (114), the strap-connection buckle (116), the suspension points (122), the chassis-attachment buckles (124), the upper strap of the headrest (126), the length and tension adjustment buckle (128), the securing carabiner (129), the headrest extension (130), the canopy access opening (131), the child restraint straps (132), the buckle adjusters for the restraint straps (134), the insertable locking elements (136), the reinforced belt passage holes (138), the central coupling element of the restraint system (140), the system release button (142), the quick-release closures (146), the flexible canopy (147), the folding textile bag (148), the bag-closing system (150), and the tightening cords or tension elements (152).

1. A hanging system for supporting a child by suspension from the chassis of a baby stroller, comprising:
a support surface formed of one or more flexible, semi-rigid, rigid, or structurally equivalent materials; and
a plurality of suspension means configured to attach said support surface to the stroller chassis, wherein the system is designed to function as an independent unit from the stroller's original seat and without requiring integrated structural components from the chassis.

2. The system of claim 1, wherein the suspension means comprise a plurality of anchoring points distributed to provide lateral and vertical stability.

3. The system of claim 1, further comprising a child restraint system configured to maintain the child in a secure position on the support surface, the restraint system comprising a plurality of adjustable retaining means.

4. The system of claim 1, further comprising an adjustable headrest connected to the upper part of the support surface via means for adjusting length and tension.

5. The system of claim 1, further comprising an extendable canopy deployable from an opening located at the top of the backrest.

6. The system of claim 1, further comprising one or more integrated pockets for storing personal items or accessories.

7. The system of claim 1, further comprising breathable zones made of mesh or microperforated fabric.

8. The system of claim 1, further comprising a folding mechanism by which the support surface can be rolled into an integrated textile bag, the bag being configured to hang from the chassis using the same suspension means.

9. The system of claim 1, wherein the support surface is made entirely or partially of functional materials selected from antibacterial, antimicrobial, or water-repellent fabrics, or materials certified for infant use.

10. The system of claim 1, wherein the headrest and the child restraint system are configured to operate in conjunction, providing ergonomic support to the child's head and torso.
